(19) United States
(12) Patent Application Publication
(10) Pub. No.: US 2016/0269258 A1
(43) Pub. Date: Sep. 15, 2016

(54) SYSTEM AND METHOD FOR MANAGING COMMUNICATION SESSIONS IN AN ENTERPRISE

(71) Applicant: Avaya Inc., Santa Clara, CA (US)

(72) Inventors: John McGreevy, Galway (IE); Neil O'Connor, Galway (IE); Tony McCormack, Galway (IE)

(21) Appl. No.: 14/642,889

(22) Filed: Mar. 10, 2015

(51) Int. Cl. H04L 12/26; H04L 12/911; G06F 17/30; H04L 29/08

(52) U.S. Cl. CPC H04L 43/0805; H04L 67/14; H04L 47/70; G06F 17/30312; G06F 17/30377

(57) ABSTRACT

A computing system for managing at least one communication session in an enterprise is disclosed. The computing system includes a monitoring module for monitoring one or more parameters associated with the at least one communication session. The system further includes a resource selection module for selecting at least one resource from one or more resources in the enterprise, wherein the at least one resource is selected by polling the one or more resources to associate the one or more resources with the one or more parameters. The system further includes a database for storing the association of the one or more parameters with the at least one selected resource. The system further includes a routing module for routing the at least one communication session to the at least one selected resource.

### BACKGROUND

1. Field

Embodiments of the present invention generally relate to a system and method to manage communication sessions in an enterprise and particularly to a system and method for routing communication sessions to suitable resources in an enterprise.

2. Description of Related Art

Contact centers are employed by many enterprises to service, inbound and outbound contacts or customers. A primary objective of contact center management is to ultimately maximize contact center performance and profitability. An ongoing challenge in contact center administration is monitoring and optimizing contact center efficiency usage of its available resources. The contact center efficiency is generally measured by metrics such as Service Level Agreement (‘SLA’), Customer Satisfaction (‘CSAT’), and match rate. Contact center resources may include, agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, given busy, canceled, flowed out). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may handle contacts of a certain nature more effectively and/or efficiently as compared to an agent of lesser skill level. There are other contact center agents who may not be as proficient as the primary skill level agent, and those agents are identified either as skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (‘KPIs’), such as revenue, estimated, actual, or predicted wait time, average speed of answer, throughput, resource utilization, resource performance, resource responsiveness and the like, to calculate performance relative to their Service Level Agreements (‘SLAs’). Operational efficiency is achieved when the KPIs are managed near, but not above, SLA threshold levels.

Throughput is a measure of the number of contacts/contact requests or communication sessions that may be processed in a given amount of time. Resource utilization is a measure of how efficiently the resources' time is being used. Customer service level is a measure of the time customers spend waiting for their work to be handled. Company contact center customers wish to provide service to as many requests as possible in a given amount of time, using the least number of resources to do so, and minimizing the wait time for their customers that may increase the Service Level Agreement (‘SLA’) of the contact center. Further, the contact center may also have to maintain the Customer Satisfaction (‘CSAT’) metrics in order to maintain the KPIs of the contact center. For this purpose, resources may have to maintain the quality of services provided to the customers through multimedia (e.g., voice contacts, video contacts, emails, etc.).

Generally, these objectives, specifically resource utilization, are achieved by routing contacts to suitable resources of the contact center. A suitable resource may be a resource that provides satisfactory services to a customer. Conventionally, multiple routing schemes were utilized to select a suitable resource to handle a communication session associated with a customer. Some of the conventional routing schemes are, but not limited to, skill based routing, work based routing, and so forth. Also, supervisors of the contact center select a suitable resource based on attributes assigned to resources along with knowledge they have about these resources. However, the supervisors can have imperfect and incomplete knowledge about the resources as the supervisors do not have personal relationships (for example, friends) with each of the resources. In an exemplary scenario, a supervisor is a friend of an agent ‘A’ and therefore knows ‘likes’ and ‘dislikes’ of the agent ‘A’, but the supervisor does not know an agent ‘B’ personally and therefore may have only professional knowledge such as assigned attributes or educational qualification, etc., about the agent ‘B’. Therefore, the supervisor may find difficulties while routing contacts to the resources. Further, some of the resources of the contact center may know the agent ‘B’ and can provide useful information about the agent ‘B’ to the supervisor. However, conventional techniques do not utilize this information while routing contacts to the suitable resource.

There is thus a need for a system and method for managing routing of communication sessions in an enterprise in a more efficient manner.

### SUMMARY

Embodiments in accordance with the present invention provide a computing system for managing at least one communication session in an enterprise. The computing system includes a monitoring module for monitoring one or more parameters associated with the at least one communication session. The system further includes a resource selection module for selecting at least one resource from one or more resources in the enterprise, wherein the at least one resource is selected by polling the one or more resources to associate the one or more resources with the one or more parameters. The system further includes a database for storing the association of the one or more parameters with the at least one selected resource. The system further includes a routing module for routing the at least one communication session to the at least one selected resource.

Embodiments in accordance with the present invention further provide a computer-implemented method for managing at least one communication session in an enterprise. The method includes monitoring one or more parameters associated with the at least one communication session; selecting at least one resource from one or more resources in the enterprise, wherein the at least one resource is selected by polling the one or more resources to associate the one or more resources with the one or more parameters; storing the association of the one or more parameters with the at least one selected resource in a database; and routing the at least one communication session to the at least one selected resource.

Embodiments in accordance with the present invention further provide a computer-implemented method for managing at least one communication session in an enterprise. The method includes monitoring one or more parameters associated with the at least one communication session; selecting at least one resource from one or more resources in the enterprise, wherein the at least one resource is selected by polling the one or more resources to associate the one or more resources with the one or more parameters, wherein one or more available resources are polled; storing the association of the one or more parameters with the at least one selected resource in a database; and routing the at least one communication session to the at least one selected resource.

Embodiments of the present invention may provide a number of advantages depending on its particular configuration. First, embodiments of the present application provide a system and a method for managing a communication session in an enterprise such as but not limited to a contact center. Next, embodiments of the present application may be used to assist a supervisor of the enterprise in the generation of teams. For example, a team having four resources may be created to respond to a query by polling resources, an informal relationship (e.g., friends) known by the resources may then be used to create a more cohesive team and conflicting personality styles may be avoided.

Next, embodiments of the present application may be used to adapt a resource or team selection based on gathered polls of the resources of the enterprise. For example, a team be requested for a customer that may include five specific parameters and the opinion of the resources was to build a team that may include ten other parameters then then embodiments of the present invention may reuse the information gathered from the resources for the next time a similar team is requested. Further, embodiments of the present invention may be used to form better functioning teams, optimize resource selection, and so forth.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 depicts a flowchart of a method for managing a communication session in the contact center, according to an embodiment of the present invention;

FIG. 4 depicts a flowchart of a method for managing a communication session in the contact center, according to another embodiment of the present invention; and

FIG. 5 depicts a flowchart of a method for creating a database having information of resources, according to an embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited for use with, e.g., a system having an Automatic Call Distribution (ACD) or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

The terms “customer” and “contact” may be used interchangeably in certain context of this disclosure of the present invention when referring to one or more persons/entity contacting a contact center, usually to reach an IVR system and/or one or more agents for assistance. In another context contemplated by the present invention, a “customer” may have more than one contact with the contact center at, or nearly at, the same time. For example, a customer may communicate with a contact center by way of telephone and by way of a chat, thus counting as one customer but two contacts.

The term “resource” may be used interchangeably in certain context with “agent” within this disclosure of the present invention when referring to one or more persons/entity servicing a contact in a contact center or a knowledge resource within an enterprise servicing back office transactions. In an embodiment of the present invention, the resource may be, but is not restricted to, an agent, an available agent, a reserve agent, a trainee agent, a Subject Matter Expert (SME), a supervisor, and so forth.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a Private Branch Exchange (PBX), an ACD, an enterprise switch, or other type of communications system switch or server, as well as other types of processor-based communication control devices such as media servers, computers, adjuncts, etc.

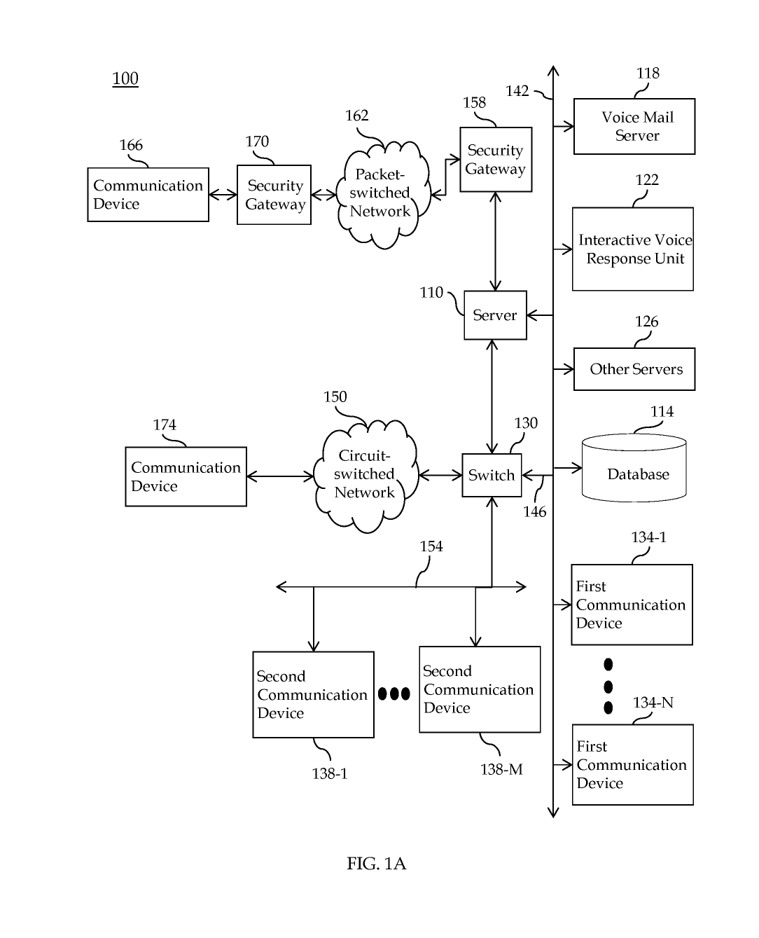

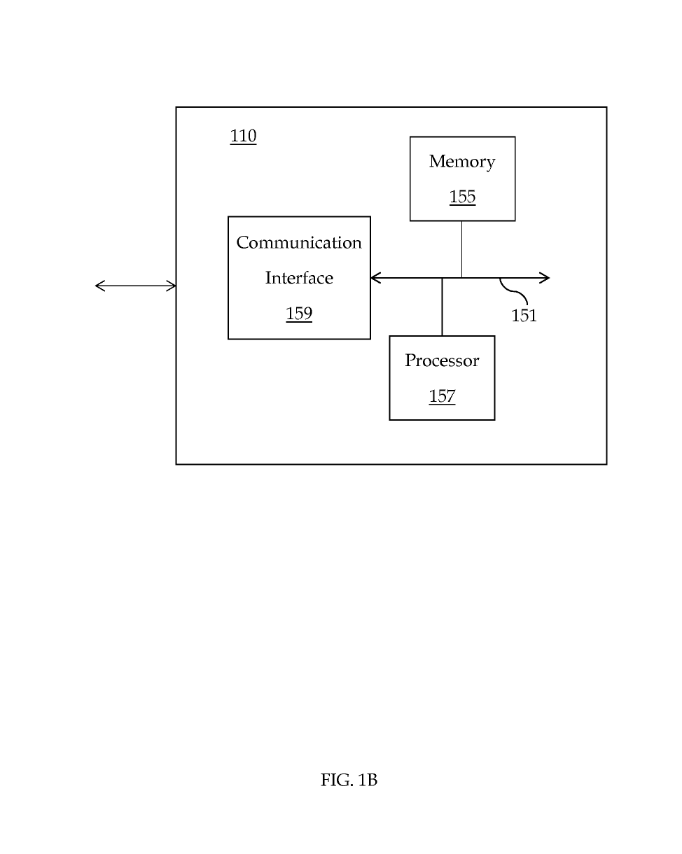

FIG. 1A shows an illustrative embodiment of the present invention. A contact center 100 comprises a server 110, a set of data stores or databases 114 containing contact or customer related information, resource related information and other information that may enhance the value and efficiency of the contact processing, and a plurality of servers, namely a voice mail server 118, an Interactive Voice Response unit (e.g., IVR) 122, and other servers 126, a switch 130, a plurality of working agents operating packet-switched (first) communication devices 134-1-N (such as computer work stations, or personal computers), and/or circuit-switched (second) communication devices 138-1-M, all interconnected by a Local Area Network (LAN) 142, (or Wide Area Network (WAN)). In another embodiment of the present invention, the customer and agent related information may be replicated over multiple repositories.

The servers may be connected via optional communication lines 146 to the switch 130. As will be appreciated, the other servers 126 may also include a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 150 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. In an embodiment of the present invention, the security gateway 158 (as shown in FIG. 1A) may be Avaya Inc.'s, G700 Media Gateway™ and may be implemented as hardware such as via an adjunct processor (as shown) or as a chip in the server 110.

The switch 130 and/or server 110 may be any architecture for directing contacts to one or more communication devices. In some embodiments of the present invention, the switch 130 may perform load-balancing functions by allocating incoming or outgoing contacts among a plurality of logically and/or geographically distinct contact centers. Illustratively, the switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya, or another company. Typically, the switch 130/server 110 is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched devices. Each of the second communication devices 138-1-M corresponds to one of a set of internal extensions Ext-1-M, respectively. The second communication devices 138-1-M may include, for example, wired and wireless telephones, PDAs, H.320 videophones and conferencing units, voice messaging and response units, traditional computer telephony adjuncts, and any other communication devices.

It should be noted that embodiments of the present invention do not require any particular type of information transport medium between switch, or server and first and second communication devices, i.e., embodiments of the present invention may be implemented with any desired type of transport medium as well as combinations of different types of transport channels.

The packet-switched network 162 may be any data and/or distributed processing network, such as the Internet. The packet-switched network 162 typically includes proxies (not shown), registrars (not shown), and routers (not shown) for managing packet flows.

The packet-switched network 162 as shown in FIG. 1A is in communication with a first communication device 166 via a security gateway 170, and the circuit-switched network 150 with an external second communication device 174.

In one configuration, the server 110, the packet-switched network 162, and the first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), IMAP4, ISDN, E1/T1, and analog line or trunk.

It should be emphasized the configuration of the switch 130, the server 110, customer communication devices, and other elements as shown in FIG. 1A is for purposes of illustration only and should not be construed as limiting embodiments of the present invention to any particular arrangement of elements.

Further, the server 110 is notified via the LAN 142 of an incoming service request or work item by the communications component (e.g., switch 130, a fax server, an email server, a web server, and/or other servers) receiving the incoming service request as shown in FIG. 1A. The incoming service request is held by the receiving telecommunications component until the server 110 forwards instructions to the component to forward or route the contact to a specific contact center resource, such as the IVR unit 122, the voice mail server 118, and/or first or second telecommunication device 134-1-N, 138-1-M associated with a selected agent.

FIG. 1B illustrates at a relatively high-level hardware abstraction of a block diagram of a server such as the server 110, in accordance with an embodiment of the present invention. The server 110 may include an internal communication interface 151 that interconnects a processor 157, a memory 155 and a communication interface circuit 159. The communication interface circuit 159 may include a receiver and transmitter (not shown) to communicate with other elements of the contact center 100 such as the switch 130, the security gateway 158, the LAN 142, and so forth. By use of programming code and data stored in the memory 155, the processor 157 may be programmed to carry out various functions of the server 110.

Although embodiments are discussed with reference to client-server architecture, it is to be understood the principles of embodiments of the present invention apply to other network architectures. For example, embodiments of the present invention apply to peer-to-peer networks, such as those envisioned by the Session Initiation Protocol (SIP). In the client-server model or paradigm, network services and the programs used by end customers to access the services are described. The client side provides a customer with an interface for requesting services from the network, and the server side is responsible for accepting customer requests for services and providing the services transparent to the customer. By contrast in the peer-to-peer model or paradigm, each networked host runs both the client and server parts of an application program. Additionally, embodiments of the present invention do not require the presence of packet- or circuit-switched networks.

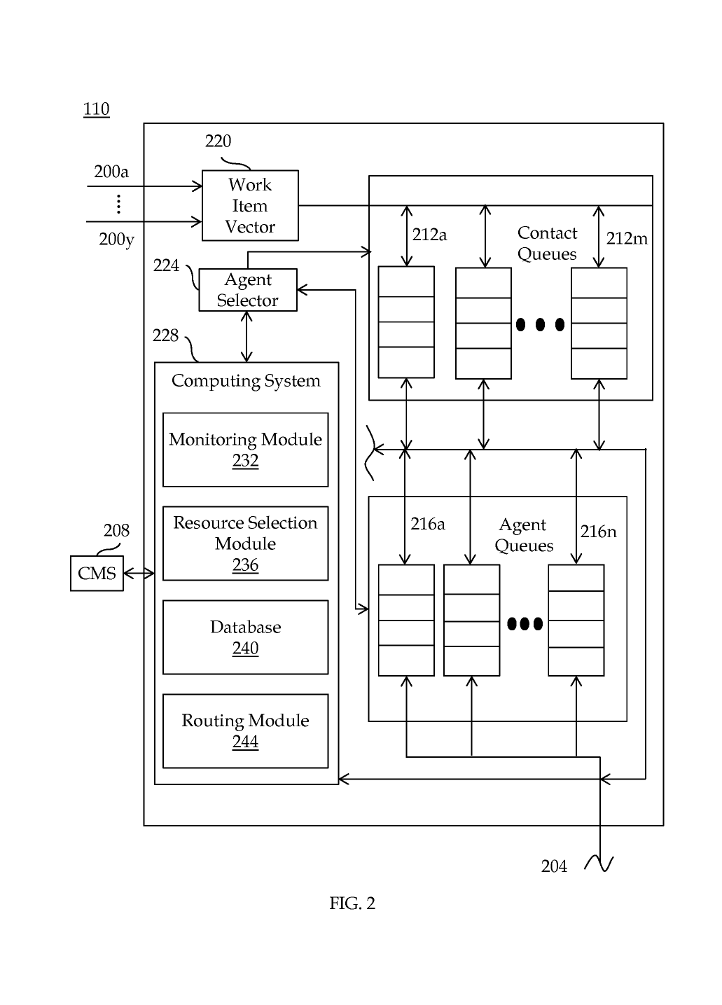

Referring to FIG. 2, one possible configuration of the server 110 is depicted at a relatively high level of functional abstraction, according to an embodiment of the present invention. The server 110 is in communication with a plurality of contact or customer communication lines 200a-y (which may be one or more trunks, phone lines, etc.) and an agent communication line 204 (which may be a voice-and-data transmission line such as the LAN 142 and/or a circuit switched voice line). The server 110 may include Avaya Inc.'s Operational Analyst™ (OA) with On-Line Analytical Processing (OLAP) technology or a Call Management System (CMS) 208 that gathers contact records. OA and CMS will hereinafter be referred to jointly as CMS 208.

As shown in FIG. 2, among the data stored in the server 110 is a set of contact queues 212a-n and a separate set of agent queues 216a-n. Each contact queue 212a-n corresponds to a different set of agent queues, as does each agent queue 216a-n. Conventionally, contacts are prioritized and either are queued in individual ones of the contact queues 212a-n in their order of priority or are queued in different ones of a plurality of contact queues 212a-n that correspond to a different priority. Likewise, each agent's queues are prioritized according to his or her level of expertise or skill in that queue, and agents are queued in either individual ones of agent queues 216a-n in their order of expertise level, or in different ones of a plurality of agent queues 216a-n that correspond to a queue and each one of which corresponds to a different expertise level. In an embodiment of the present invention, the agent queue 216a-n may include a set of reserve agents queue in the contact center 100.

According to an embodiment of the present invention, included among the control programs in the server 110 is a work item vector 220. Contacts or communication sessions incoming to the contact center 100 are assigned by the work item vector 220 to different contact queues 212a-n based upon a number of predetermined criteria, including a customer's identity, customer needs, contact center needs, current contact center queue lengths, a customer value, and an agent skill that is required for proper handling of the contact. Agents who are available for handling work items are assigned to the agent queues 216a-n based upon the skills that they possess. An agent may have multiple skills, and hence may be assigned to multiple agent queues 216a-n simultaneously. Furthermore, an agent may have different levels of skill expertise (e.g., skill levels 1-N in one configuration or merely primary skill levels and secondary skill levels in another configuration), and hence may be assigned to different agent queues 216a-n at different expertise levels.

In one configuration, the contact center 100 is operated by a contract operator (e.g., a supervisor or a manager of the contact center 100), and each of the contact queues 212a-n, and possibly each of the agent queues 216a-n, corresponds to a different client such as but not limited to a customer. Each client may have a separate Service Level Agreement (‘SLA’) or other type of performance measurement agreement with the contract operator regarding performance expectations, goals, requirements or specifications for the client's respective queue(s).

Further, embodiments in accordance with the present invention may include, among the programs executing on the server 110, an agent selector 224 and a computing system 228. The agent selector 224 and the computing system 228 are stored either in the main memory or in a peripheral memory (e.g., disk, CD ROM, etc.) or some other computer-readable medium of the contact center 100. Further, the agent selector 224 monitors the occupants of the contact and agent queues 212a-n and 216a-n, respectively, and contact center objectives, rules, and policies and select agents to service work items.

The agent selector 224 distributes and connects these work items to communication devices of available agents based on the predetermined criteria noted above. When the agent selector 224 forwards a contact (or first communication session) to a resource, the agent selector 224 also forwards customer-related information from the database 114 to the resource's desktop or computer work station for previewing and/or viewing (such as by a pop-up display) to enable the resource for providing better services to the customer. Depending on the contact center configuration, the agent selector 224 may reallocate the contact to the resources of the contact center 100. The resources process the contacts or communication sessions sent to them by the agent selector 224.

In an embodiment of the present invention, the agent and their associated data are maintained and updated in the database 114 of the contact center 100. Upon the completion of handling a contact, a generator (not shown) collects selected metrics for the contact. These metrics may include skills involved in servicing the contact, an identifier of a servicing resource, contact duration, a transaction or contact type (e.g., sale, information request, complaint, etc.), time-of-day, result of the contact (e.g., type of sale, number of units sold, an average revenue generated, etc.), and so forth. The metrics along with other statistics is typically gathered by the CMS 208.

According to an embodiment of the present invention, the computing system 228 includes certain modules, such as, but not restricted to, a monitoring module 232, a resource selection module 236, a database 240, and a routing module 244. In some embodiments, one or more of the monitoring module 232, the resource selection module 236, the database 240, and the routing module 244 may be implemented by one or more software processes running on the server 110. The server 110 may implement one or more software processes by use of the processor 157 being suitably programmed by use of software instructions stored in the memory 155 coupled to the processor 157.

The monitoring module 232 may monitor parameters associated with a communication session, according to an embodiment of the present invention. In an embodiment of the present invention, the monitoring module 232 may monitor a type of the communication session. The type of the communication session may include, but not restricted to, a voice session, a video session, a Short Message Service (SMS), a web chat session, an Instant Messaging (IM) session, an email communication session, an Interactive Voice Response (IVR) session, a Voice over Internet Protocol (VOIP) session, and so forth. In an embodiment of the present invention, the communication session may be initiated by a customer of the contact center 100. Further, the monitoring module 232 may monitor static details of the communication session, according to an embodiment of the present invention. The monitoring module 232 may monitor static details of the communication session by monitoring inputs selected by the customer in an IVR menu of the contact center 100, in an embodiment of the present invention.

The monitoring module 232 may further monitor details of the customer associated with the communication session, according to an embodiment of the present invention. The details of the customer may include, but not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, and so forth. In an embodiment of the present invention, the monitoring module 232 may extract the details of the customer from various social networking websites. Furthermore, the monitoring module 232 may monitor a type of the customer, according to an embodiment of the present invention. In an exemplary scenario, a customer may be, but not restricted to, a high priority customer, a medium priority customer, and/or a low priority customer. A customer having higher revenue products and/or services provided by the contact center 100 may be referred as a high priority customer. A customer having medium revenue products and/or services provided by the contact center 100 may be referred as a medium priority customer. Further, a customer having low revenue products and/or services provided by the contact center 100, or a potential customer of the contact center 100 may be referred as a low priority customer.

Further, the monitoring module 232 may monitor details of resources of the contact center 100, according to an embodiment of the present invention. The details of a resource may include, but not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth. As used herein, the term ‘skill set’ refers to a set of resource data that may be used by the contact center 100 to characterize a resource. Such resource data may include, but not restricted to, biographical resource data, demographic resource data, external or internal behavioral resource data, to name a few. The behavioral data may include the resource's history with respect to the contact center 100 and/or any other entity or social media channel. However, the resource data is not limited in this regard and may include any other type of resource data used by the contact center 100 to characterize or classify the resources of the contact center 100. Further, the resource data may include any other resource data collected from one or more sources external to the contact center 100. Additionally, a resource profile having the details of a resource may be raw resource data or processed resource data. That is, the resource data may be analyzed to characterize the resource and thereafter used to provide customized or personalized services to the customer. For example, a resource profile may be a set of values associated with a resource and a set of characteristics, where the values may be selected based on the resource data obtained. However, the present application is not limited in this regard and any other methods for evaluating resource data to provide services may be used without limitation.

Furthermore, the monitoring module 232 may monitor occupancy of the resources within the contact center 100, according to an embodiment of the present invention. The monitoring module 232 may monitor the occupancy of the resources by monitoring workload of the resources within the contact center 100, in an embodiment of the present invention. The workload may include, but not restricted to, a number of contacts or communication sessions allocated to a resource of the contact center 100. The monitoring module 232 may monitor occupancy of the resources by monitoring their working states, in another embodiment of the present invention. The working state of a resource may include, but not restricted to, a busy state, an available state, an out of seat state, on a break state, do-not-disturb state, and so forth.

The monitoring module 232 may further determine context of the communication session, according to an embodiment of the present invention. The context of the communication session may include, but not restricted to, a product inquiry support, a sales support, a health, or car policy support, a financial transaction support, and so forth. In an exemplary scenario, a customer may provide inputs in an IVR menu of the contact center 100 for a ‘car insurance policy’, then it may be determined that context of the communication session is a product inquiry support for a car insurance policy. Furthermore, the monitoring module 232 may extract keywords from the monitored communication session, according to an embodiment of the present invention. In an exemplary scenario, a customer may inquire about ‘car insurance policy inquiry’ then the monitoring module 232 may extract keywords such as ‘inquiry’, ‘car insurance’ and ‘policy’ from the communication session.

In an embodiment of the present invention, the monitoring module 232 may monitor the parameters associated with the communication session in a real-time environment. The parameters associated with the communication session may include, but not restricted to, a type of a communication session, context of a communication session, static details of a communication session, details of a customer, details of a resource, occupancy of resources, and so forth, in an embodiment of the present invention. However, embodiments of the present application are not limited in this regard and may include other parameters associated with the communication session that may be used without limitation.

The resource selection module 236 may enable the resources to poll in order to associate the monitored parameters with the resources of the contact center 100, according to an embodiment of the present invention. In an embodiment of the present invention, only available agents of the contact center 100 are polled. The resources of the contact center 100 may poll based on criteria, according to an embodiment of the present invention. The criteria may include, but not restricted to, a questionnaire, in an embodiment of the present invention. The resources may poll by providing their responses for the questionnaires, in an embodiment of the present invention. In an exemplary scenario, a question ‘who is a resource from a list of available resources is best suited to provide a customer service to a communication session having parameters ‘English’, ‘furniture’, and ‘sofa’’ may be asked to the resources of the contact center 100. In another exemplary scenario, two resources sit down for a coffee during a break and discussing about their work issues associated with health insurance policy, and a third agent may be silently listening to the discussion, then the two resources may realize that the third agent may help if a similar communication session comes in the contact center 100. In an embodiment of the present invention, the questionnaire may be displayed on the resources' desktops as a pop-up display. In another embodiment of the present invention, the questionnaire may be provided in emails to the resources of the contact center 100. The questionnaire may be provided as an Instant Messaging (IM) to the resources of the contact center 100, in yet another embodiment of the present invention. The questionnaire may be displayed to the occupied resources of the contact center 100, according to an embodiment of the present invention. In another embodiment of the present invention, the questionnaire may be displayed to the available resources of the contact center 100. In yet another embodiment of the present invention, the questionnaire may be displayed to a combination of the occupied and available resources of the contact center 100. The polling of the resources may be done in a real-time environment, according to an embodiment of the present invention. The polling of the resources may be done in an off-line mode, according to another embodiment of the present invention. In an exemplary scenario, a question to find a suitable resource for a set of parameters is asked to 10,000 resources and the resources of the contact center 100 may poll within 24 hours. In an embodiment of the present invention, the resource selection module 236 may generate parameters associated with a communication session. In an exemplary scenario, parameters associated with a communication session are auto-generated and are displayed to resources of the contact center 100. In another exemplary scenario, the supervisor of the contact center 100 may generate parameters associated with the communication session. The resources of the contact center 100 then polls to suggest a suitable resource for the communication session based on the parameters.

Further, the resource selection module 236 may gather responses to the questionnaire from the resources of the contact center 100, according to an embodiment of the present invention. In continuation of the above example, one of the available resources, an agent ‘A’, presented in the list has bought a house and some of the colleagues of the agent ‘A’ know about it then the colleagues may suggest or poll that the agent ‘A’ should answer the communication session to provide better customer service to the customer related to ‘furniture’ and ‘sofa’ as the agent ‘A’ may have valuable information about ‘furniture’ from personal experience. In an exemplary scenario, the resources may suggest only one available resource from the list of available resources. In another exemplary scenario, the resources may suggest more than one available resource from the list of available resources. Furthermore, the resource selection module 236 may select a resource from the list of available resources, according to an embodiment of the present invention. The resource selection module 236 may select a resource from the list of available resources by generating a score for the resources based on the association. In an exemplary scenario, a resource that is associated with parameters by maximum number of resources is selected. Therefore, a collective opinion or suggestion of the resources of the contact center 100 may be used to select a resource. Moreover, the resource selection module 236 may associate the resources with the parameters associated with the communication session, according to an embodiment of the present invention. In above exemplary scenario, the agent ‘A’ may be associated with the parameters ‘furniture’ and ‘sales’.

The database 240 may store the association of the parameters with the selected resource, according to an embodiment of the present invention. In an embodiment of the present invention, the database 240 may be created having the association of the parameters with the selected resource. The database 240 may be updated based on the association of the parameters with the selected resource, in another embodiment of the present invention. Further, the scores associated with the resources are stored in the database 240. The database 240 may be an internal database of the contact center 100, in an embodiment of the present invention. In another embodiment of the present invention, the database 240 may be the database 114 of the contact center 100. The database 240 may be a third-party hosted database, according to yet another embodiment of the present invention.

The routing module 244 may route the communication session to the selected resource based on the association, according to an embodiment of the present invention. The routing module 244 may establish a communication link between the customer and the selected resource of the contact center 100. In an embodiment of the present invention, the selected resource may be, but is not restricted to, an available agent, a reserve agent, a trainee agent, a Subject Matter Expert (SME), a supervisor, and so forth.

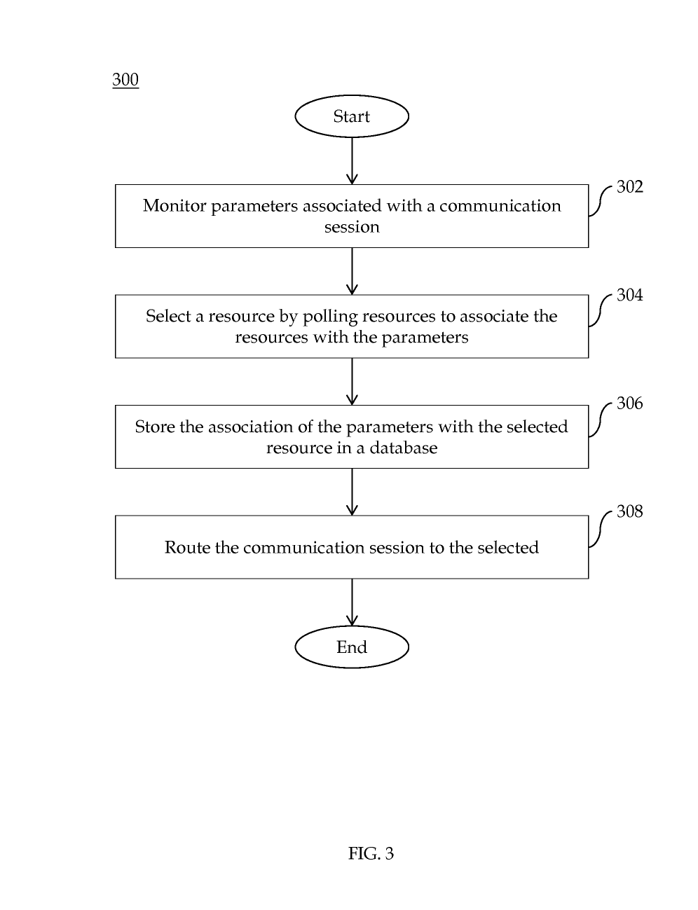

FIG. 3 depicts a flowchart of a method 300 for managing a communication session in the contact center 100, according to an embodiment of the present invention

At step 302, the computing system 228 monitors parameters associated with the communication session, according to an embodiment of the present invention. In an embodiment of the present invention, the computing system 228 monitors a type of the communication session. The type of the communication session may include, but not restricted to, a voice session, a video session, a Short Message Service (SMS), a web chat, an Instant Messaging (IM), an email communication, an Interactive Voice Response (IVR) session, a Voice over Internet Protocol (VOIP) session, and so forth. Further, the computing system 228 monitors static details of the communication session by monitoring inputs selected by the customer in an IVR menu of the contact center 100, according to an embodiment of the present invention.

The computing system 228 further monitors details of the customer associated with the communication session, according to an embodiment of the present invention. The details of the customer may include, but not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, and so forth. Furthermore, the computing system 228 monitors a type of the customer, according to an embodiment of the present invention. In an exemplary scenario, a customer may be, but not restricted to, a high priority customer, a medium priority customer, and/or a low priority customer.

Further, the computing system 228 monitors details of resources of the contact center 100, according to an embodiment of the present invention. The details of a resource may include, but not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth.

Furthermore, the computing system 228 monitors occupancy of the resources by monitoring their workload within the contact center 100, in an embodiment of the present invention. The workload may include, but not restricted to, a number of contacts or communication sessions allocated to a resource of the contact center 100. The computing system 228 monitors occupancy of the resources by monitoring their working states, in another embodiment of the present invention. The working state of a resource may include, but not restricted to, a busy state, an available state, an out of seat state, on a break state, do-not-disturb state, and so forth.

The computing system 228 further determines context of the communication session, according to an embodiment of the present invention. The context of the communication session may include, but not restricted to, a product inquiry support, a sales support, a health, or car policy support, a financial transaction support, and so forth. Furthermore, the computing system 228 extracts keywords from the monitored communication session, according to an embodiment of the present invention. In an embodiment of the present invention, the monitoring module 232 may monitor the parameters associated with the communication session in a real-time environment.

At step 304, the computing system 228 selects a resource based on polling by the resources of the contact center 100, according to an embodiment of the present invention. The computing system 228 enables the resources for polling to associate the monitored parameters with the resources of the contact center 100, according to an embodiment of the present invention. These resources may poll based on criteria, for example, but not restricted to, a questionnaire, in an embodiment of the present invention. In an embodiment of the present invention, the questionnaire may be provided, but not restricted to, as a pop-up display, in an email, as an Instant Messaging (IM), and so forth. The questionnaire may be displayed to the occupied resources, available resources, or a combination thereof. The polling of the resources may be done in a real-time environment, according to an embodiment of the present invention. The polling of the resources may be done in an off-line mode, according to another embodiment of the present invention. The resources of the contact center 100 then polls to suggest a suitable resource for the communication session based on the monitored parameters.

Further, the computing system 228 gathers responses (suggestions or opinions) to the questionnaire from the resources of the contact center 100, according to an embodiment of the present invention. Moreover, the computing system 228 associates the monitored parameters with the selected resource, according to an embodiment of the present invention.

At step 306, the computing system 228 stores the association of the monitored parameters with the selected resource in a database, according to an embodiment of the present invention. In an embodiment of the present invention, the database may be created having the association of the monitored parameters with the selected resource. The database 240 may be updated based on the association of the monitored parameters with the selected resource, in another embodiment of the present invention.

At step 308, the computing system 228 routes the communication session to the selected resource based on the association, according to an embodiment of the present invention. The computing system 228 establishes a communication link between the customer and the selected resource of the contact center 100. In an embodiment of the present invention, the selected resource may be, but is not restricted to, an available agent, a reserve agent, a trainee agent, a Subject Matter Expert (SME), a supervisor, and so forth.

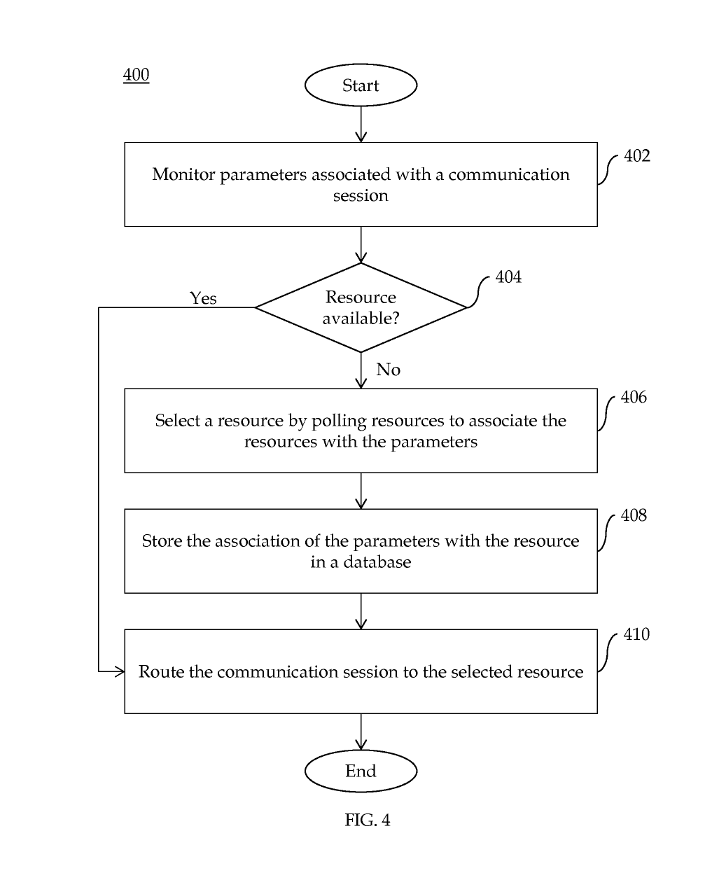

FIG. 4 depicts a flowchart of a method 400 for managing a communication session in the contact center 100, according to another embodiment of the present invention.

At step 402, computing system 228 monitors parameters associated with the communication session, according to an embodiment of the present invention. In an embodiment of the present invention, the computing system 228 monitors a type of the communication session. The type of the communication session may include, but not restricted to, a voice session, a video session, a Short Message Service (SMS), a web chat, an Instant Messaging (IM), an email communication, an Interactive Voice Response (IVR) session, a Voice over Internet Protocol (VOIP) session, and so forth. Further, the computing system 228 monitors static details of the communication session by monitoring inputs selected by the customer in an IVR menu of the contact center 100, according to an embodiment of the present invention.

The computing system 228 further monitors details of the customer associated with the communication session, according to an embodiment of the present invention. The details of the customer may include, but not restricted to, personal information (for example, a name, a social networking username, etc.), contact information (for example, a telephone number, an email address, etc.), educational background, business contacts, education and work histories, likes, hobbies, favorite sport teams, frequency of conversations with a resource, a history of queries, a customer identification, communication history with the contact center 100, and so forth. Furthermore, the computing system 228 monitors a type of the customer, according to an embodiment of the present invention. In an exemplary scenario, a customer may be, but not restricted to, a high priority customer, a medium priority customer, and/or a low priority customer.

Further, the computing system 228 monitors details of resources of the contact center 100, according to an embodiment of the present invention. The details of a resource may include, but not restricted to, a name, a phone number, an extension number, resource identification (ID), social networking usernames, a resource's interests, hobbies, hometowns, favorite sport teams and TV shows, cultural background, education and work histories, skill set, technical training or experience in supporting a particular industry, company, or contact, and so forth. Furthermore, the computing system 228 monitors occupancy of the resources by monitoring their workload within the contact center 100, in an embodiment of the present invention. The workload may include, but not restricted to, a number of contacts or communication sessions allocated to a resource of the contact center 100. The computing system 228 monitors occupancy of the resources by monitoring their working states, in another embodiment of the present invention. The working state of a resource may include, but not restricted to, a busy state, an available state, an out of seat state, on a break state, do-not-disturb state, and so forth.

The computing system 228 further determines context of the communication session, according to an embodiment of the present invention. The context of the communication session may include, but not restricted to, a product inquiry support, a sales support, a health, or car policy support, a financial transaction support, and so forth. Furthermore, the computing system 228 extracts keywords from the monitored communication session, according to an embodiment of the present invention. In an embodiment of the present invention, the monitoring module 232 may monitor the parameters associated with the communication session in a real-time environment. In one embodiment, the keywords are extracted from the monitored parameters of the communication session.

At step 404, the computing system 228 determines whether a resource is available to handle the communication session, according to an embodiment of the present invention. If the computing system 228 determines that a resource is available to handle the communication session, then the method 400 proceeds towards a step 410. Otherwise, the method proceeds to a step 406.

At the step 406, the computing system 228 selects a resource based on polling by the resources of the contact center 100, according to an embodiment of the present invention. The computing system 228 enables the resources for polling to associate the monitored parameters with the resources of the contact center 100, according to an embodiment of the present invention. These resources may poll based on criteria, for example, but not restricted to, a questionnaire, in an embodiment of the present invention. In an embodiment of the present invention, the questionnaire may be provided, but not restricted to, as a pop-up display, in an email, as an Instant Messaging (IM), and so forth. The questionnaire may be displayed to the occupied resources, available resources, or a combination thereof. The polling of the resources may be done in a real-time environment, according to an embodiment of the present invention. The polling of the resources may be done in an off-line mode, according to another embodiment of the present invention. The resources of the contact center 100 then polls to suggest a suitable resource for the communication session based on the monitored parameters.

Further, the computing system 228 gathers responses (or suggestions) to the questionnaire from the resources of the contact center 100, according to an embodiment of the present invention. Moreover, the computing system 228 associates the monitored parameters with the selected resource, according to an embodiment of the present invention.

At step 408, the computing system 228 stores the association of the monitored parameters with the selected resource in a database, according to an embodiment of the present invention. In an embodiment of the present invention, the database may be created having the association of the monitored parameters with the selected resource. The database 240 may be updated based on the association of the monitored parameters with the selected resource, in another embodiment of the present invention.

At the step 410, the computing system 228 routes the communication session to the selected resource based on the association, according to an embodiment of the present invention. The computing system 228 establishes a communication link between the customer and the selected resource of the contact center 100. In an embodiment of the present invention, the selected resource may be, but is not restricted to, an available agent, a reserve agent, a trainee agent, a Subject Matter Expert (SME), a supervisor, and so forth.

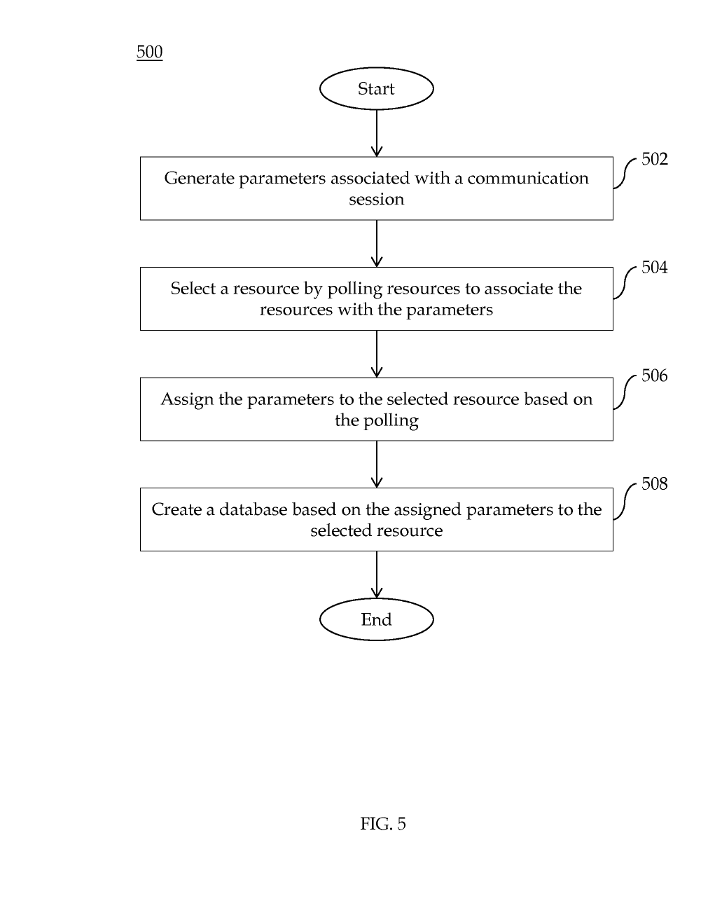

FIG. 5 depicts a flowchart of a method 500 for creating a database having information of resources, according to an embodiment of the present invention. At step 502, the computing system 228 generates parameters associated with a communication session, according to an embodiment of the present invention. The communication session may be, but is not restricted to, an imaginary communication session, in an embodiment of the present invention. Based on the communication session, parameters may be generated. In an exemplary scenario, parameters such as, but not restricted to, ‘English’, ‘mobile phone’, and ‘sales inquiry’ may be generated. The parameters of the communication session may be generated automatically, in an embodiment of the present invention. In another embodiment of the present invention, the parameters of the communication session may be generated by the supervisor of the contact center 100.

At step 504, the computing system 228 selects a resource based on polling by the resources of the contact center 100, according to an embodiment of the present invention. The computing system 228 enables the resources for polling to associate the parameters with the resources of the contact center 100, according to an embodiment of the present invention. These resources may poll based on criteria, for example, but not restricted to, a questionnaire, in an embodiment of the present invention. In the above exemplary scenario, a question ‘who is a suitable resource to handle a mobile phone sales inquiry in English’ may be provided to the resources of the contact center 100 then the resource may poll for a suitable resource. The questionnaire may be displayed to the occupied resources, available resources, or a combination thereof. In an embodiment of the present invention, the questionnaire may be provided, but not restricted to, as a pop-up display, in an email, as an Instant Messaging (IM), and so forth. The resources of the contact center 100 then polls to suggest a suitable resource for the generated parameters associated with the communication session based on the monitored parameters.

Further, the computing system 228 gathers responses (or suggestions) to the questionnaire from the resources of the contact center 100, according to an embodiment of the present invention. Moreover, the computing system 228 associates the parameters with the selected resource, according to an embodiment of the present invention. In the continuation of the above exemplary scenario, the resources may poll for an agent ‘A’ then the agent ‘A’ may be selected as a suitable resource to handle a mobile phone sales inquiry in English.

At step 506, the computing system 228 assigns the parameters to the selected resource, according to an embodiment of the present invention. In the above exemplary scenario, the parameters ‘English’, ‘mobile phone’, ‘sales inquiry’ may be then assigned to the agent ‘A’.

At step 508, the computing system 228 creates a database having the association of the parameters with the selected resource, in an embodiment of the present invention. The computing system 228 updates the database 240 based on the association of the monitored parameters with the selected resource, in another embodiment of the present invention.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computation efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computing system for managing at least one communication session in an enterprise, the system comprising:
a monitoring module for monitoring one or more parameters associated with the at least one communication session;
a resource selection module for selecting at least one resource from one or more resources in the enterprise, wherein the at least one resource is selected by polling the one or more resources to associate the one or more resources with the one or more parameters;
a database for storing the association of the one or more parameters with the at least one selected resource; and
a routing module for routing the at least one communication session to the at least one selected resource.

2. The system of claim 1, wherein the monitoring module further extracts keywords from the one or more monitored parameters of the communication session.

3. The system of claim 1, wherein one or more available resources are polled.

4. The system of claim 1, wherein the polling is based on one or more criteria.

5. The system of claim 1, wherein the at least one resource is selected by generating a score for the resource based on the association.

6. The system of claim 5, wherein the database includes the score for the resource.

7. The system of claim 1, wherein the database is created in an off-line mode.

8. The system of claim 1, wherein the database is updated based on the association of the one or more parameters with the at least one selected resource.

9. The system of claim 1, wherein the routing module further establishes at least one communication link between at least one customer and the selected resource.

10. The system of claim 1, wherein the at least one selected resource is one of a reserve agent, an available agent, a supervisor, or a Subject Matter Expert (SME).

11. A computer-implemented method for managing at least one communication sessions in an enterprise, the method comprising:
monitoring one or more parameters associated with the at least one communication session;
selecting at least one resource from one or more resources in the enterprise, wherein the at least one resource is selected by polling the one or more resources to associate the one or more resources with the one or more parameters;
storing the association of the one or more parameters with the at least one selected resource in a database; and
routing the at least one communication session to the at least one selected resource.

12. The method of claim 11, wherein one or more available resources are polled.

13. The method of claim 11, wherein the polling is based on one or more criteria.

14. The method of claim 11, wherein the at least one resource is selected by generating a score for the resource based on the association.

15. The method of claim 14, wherein the database includes the score for the resource.

16. The method of claim 11, wherein the database is created in an off-line mode.

17. The method of claim 11, wherein the database is updated based on the association of the one or more parameters with the at least one selected resource.

18. A computer-implemented method for managing at least one communication session in an enterprise, the method comprising:
monitoring one or more parameters associated with the at least one communication session;
selecting at least one resource from one or more resources in the enterprise, wherein the at least one resource is selected by polling the one or more resources to associate the one or more resources with the one or more parameters, wherein one or more available resources are polled;
storing the association of the one or more parameters with the at least one selected resource in a database; and
routing the at least one communication session to the at least one selected resource.

19. The method of claim 18, wherein the polling is based on one or more criteria.

20. The method of claim 18, wherein the at least one resource is selected based on a collective opinion of the one or more resources in the enterprise.
